(19) United States
(12) Patent Application Publication
(10) Pub. No.: US 2024/0119050 A1
(43) Pub. Date: Apr. 11, 2024

(54) METHOD AND SYSTEM FOR EXTENDING QUERY PROCESSING WITH DIFFERENTIABLE OPERATORS

(71) Applicant: Microsoft Technology Licensing, LLC, Redmond, WA (US)

(72) Inventors: Matteo INTERLANDI, Torrance, CA (US); Apurva Sandeep Gandhi, Union City, CA (US); Yuki Asada, Arlington, MA (US); Advitya Gemawat, Cambridge, MA (US); Victor Renjie Fu, Boston, MA (US); Lihao Zhang, Quincy, MA (US); Rathijit Sen, Redmond, WA (US); Dalitso Hansini Banda, Mountain View, CA (US)

(21) Appl. No.: 17/963,809

(22) Filed: Oct. 11, 2022

(51) Int. Cl. G06F 16/2453; G06F 16/242

(52) U.S. Cl. CPC G06F 16/24542; G06F 16/2448; G06F 16/24537

(57) ABSTRACT

Example aspects include techniques for query processing over deep neural network runtimes. These techniques include receiving a query including a query operator and a trainable user defined function (UDF). In addition, the techniques include determining a query representation based on the query, and determining, for performing the query in a neural network runtime, an initial neural network program based on the query representation, the initial neural network program including a differentiable operators corresponding to the query operator. and executing the neural network program in the neural network runtime over the neural network data structure to generate a query result. Further, the techniques include training the initial neural network program via the neural network runtime to determine a trained neural network program, and executing the trained neural network program in the neural network runtime to generate inference information.

### BACKGROUND

Deep Learning (DL) has created a growing demand for simpler ways to develop complex models and efficient ways to execute them. Thus, significant effort has gone into development of frameworks with deep neural network (DNN) runtimes to support a variety of DL models that run seamlessly over heterogeneous and distributed hardware. Increasingly, specialized hardware and hardware acceleration are being used in DL applications to support DL models. As a result, some advances have been made to perform database operations on DL systems. However, these developments have only produced techniques for fixed execution of database operations on DL systems. The aforementioned advances have not provided trainable database operations within DL systems.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method including: receiving a query including a query operator and a trainable user defined function (UDF); determining a query representation based on the query; determining, for performing the query in a neural network runtime, an initial neural network program based on the query representation, the initial neural network program including a differentiable operator corresponding to the query operator; training the initial neural network program via the neural network runtime to determine a trained neural network program; and executing the trained neural network program in the neural network runtime to generate inference information.

In some aspects, the techniques described herein relate to a non-transitory computer-readable device having instructions thereon that, when executed by at least one computing device, causes the at least one computing device to perform operations including: receiving a query including a query operator and a trainable user defined function (UDF); determining a query representation based on the query; determining, for performing the query in a neural network runtime, an initial neural network program based on the query representation, the initial neural network program including a differentiable operator corresponding to the query operator; training the initial neural network program via the neural network runtime to determine a trained neural network program; and executing the trained neural network program in the neural network runtime to generate inference information.

In some aspects, the techniques described herein relate to a system including: a memory storing instructions thereon; and at least one processor coupled with the memory and configured by the instructions to: receive a query including a query operator and a trainable user defined function (UDF); determine a query representation based on the query; determine, for performing the query in a neural network runtime, an initial neural network program based on the query representation, the initial neural network program including a differentiable operator corresponding to the query operator; train the initial neural network program via the neural network runtime to determine a trained neural network program; and execute the trained neural network program in the neural network runtime to generate inference information.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 illustrates an example architecture of a computing system implementing query processing over deep neural network (DNN) runtimes, in accordance with some aspects of the present disclosure.

FIG. 2 is a diagram illustrating example components of a trainable query, in accordance with some aspects of the present disclosure.

FIG. 3 is a diagram illustrating an example process for encoding tabular information to implement a differentiable operation, in accordance with some aspects of the present disclosure.

FIG. 4 is a diagram illustrating an example process for generating a mask from an encoded representation to implement a differentiable operation, in accordance with some aspects of the present disclosure.

FIG. 5 is a diagram illustrating an example process 500 for implementing differentiable aggregation using count operation using a mask, in accordance with some aspects of the present disclosure.

FIG. 6 is a diagram illustrating an example process for implementing differentiable aggregation using sum operation using a mask, in accordance with some aspects of the present disclosure.

FIG. 7 is a diagram illustrating an example process for implementing differentiable aggregation with max operation using a mask, in accordance with some aspects of the present disclosure.

FIG. 8 is a diagram illustrating an example process for implementing differentiable aggregation with a filter operation, in accordance with some aspects of the present disclosure.

FIG. 9 is a flow diagram illustrating an example method for query processing over DNN runtimes, in accordance with some aspects of the present disclosure.

FIG. 10 is a block diagram illustrating an example of a hardware implementation for a computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for extending query languages to express neurosymbolic systems trainable over deep neural network (DNN) runtimes. In particular, aspects of the present disclosure provide a query processing system configured to generate a DNN program from a database query including a user defined function that employs a machine learning model, train the DNN program over multi-platform DNN runtimes, and utilize the trained DNN program to determine inferences.

For example, a data processing system may embed an image recognition model within a query and train the query to perform a specific task on images. For instance, the query may be trained to count the number of digits of a particular size in an image. Accordingly, query processing system performance may be improved while reducing development effort, leveraging the cross-platform compilation capabilities of DNN runtimes, and providing the ability to perform queries including machine learning prediction. Moreover, in some aspects, the combination of query operators with ML models improves ML model training and ML model performance in areas where pure DL applications have failed or underwhelmed. Further, the combination of query operators with ML models has the benefit of not requiring a ML model to learn how to perform the query operations in pure DL applications.

### Illustrative Environment

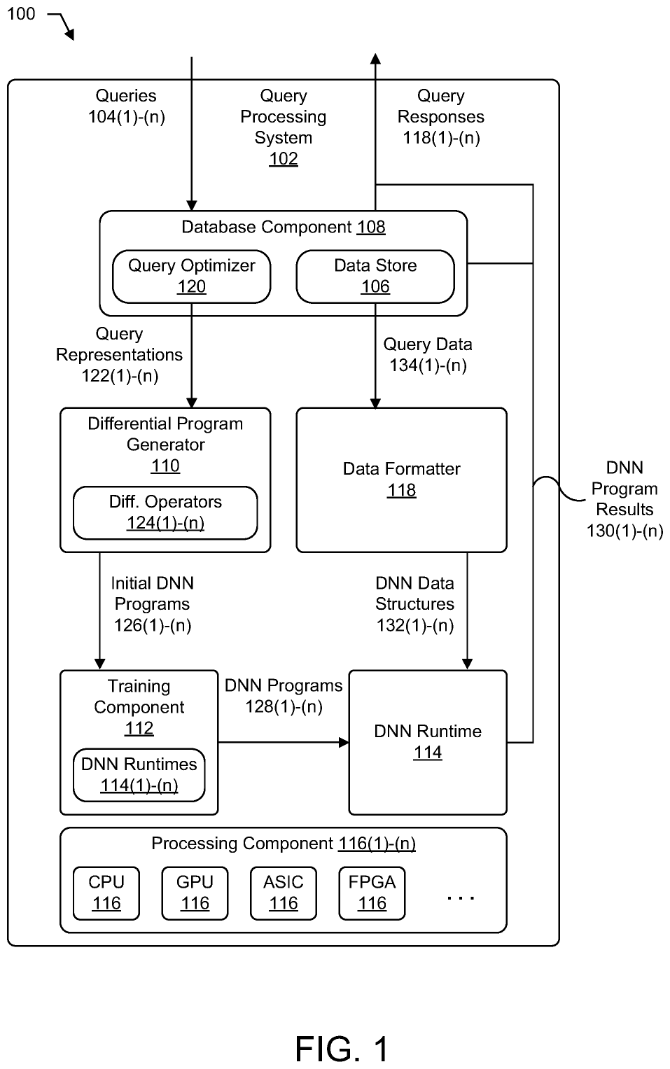

FIG. 1 is a diagram showing an example of a data processing system 100, in accordance with some aspects of the present disclosure.

As illustrated in FIG. 1, the data processing system 100 includes a query processing system 102 configured to process queries 104 over a data store 106. The data processing system 100 further includes a database component 108, a differentiable program generator 110, a training component 112, a DNN runtime 114, a data formatter 118, and one or more processing components 116.

In some aspects, the query processing system 102 may be a client device. Some examples of a client device include computing devices, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, virtual machines, etc. In some aspects, the query processing system 102 is a cloud computing platform that provides other computing devices with distributed storage and access to software, services, files, and/or data via one or more network(s), e.g., cellular networks, wireless networks, local area networks (LANs), wide area networks (WANs), personal area networks (PANs), the Internet, or any other type of network configured to communicate information between computing devices. As an example, the data processing system 100 may be a provider of software as a service (SaaS), search engine as a service (SEaaS), database as a service (DaaS), storage as a service (STaaS), big data as a service (BDaaS) in a multi-tenancy environment via the Internet, and the query processing system 102 may be used to services queries 104(1)-(n) submitted to the data processing system 100. Further, in some aspects, a query 104 includes a user defined function (UDF) and one or more differentiable SQL operators. The UDF may employ one or more ML models. Further, in some aspects, each ML model is configured to determine an inference based off of input information. In some aspects, the ML models within a UDF are CNNs or DNNs. As used herein, in some aspects, “differentiable” may refer to a function or operator whose derivative (or gradient for multivariate functions) exists and can be computed for all inputs in its domain.

The database component 108 may be configured to organize a collection of data on the data store 106. In some aspects, the data store 106 and database component 108 may reside on a single storage device or system or on multiple storage devices or systems such as available at one or more data centers. Further, the database component 108 includes various types of database services (e.g., relational, non-relational, structured query language (SQL), noSQL) for storing, querying, and updating data. As illustrated in FIG. 1, in some aspects, the database component 108 may receive the queries 104(1)-(n) and transmit corresponding query responses 118(1)-(n). Further, the database component 108 may organize data of the data store 106 for any of various types of data processing services (e.g., query processing to perform functions such as anomaly detection, machine learning, data lookup, or any other type of data processing operation).

As illustrated in FIG. 1, the database component 108 includes a query optimizer 120 configured to generate query representations 122(1)-(n). For instance, the query optimizer 120 may receive the query 104(1) and generate the query representation 122(1) corresponding to the query 104(1). In some aspects, a query representation 122 is a query plan. As used herein, a “query plan” may refer to one or more commands for executing a query over data. Further, in some aspects, the query 104(1) includes a first plurality of commands and the query representation 122(1) includes a second plurality of commands that are optimized to perform the query 104(1) over the data store 106. Additionally, a query representation 122 may be of a different format than the corresponding query 104. For example, the query representation 122(1) may encode the query as a graph and the commands of the query representation may be nodes of the graph. Additionally, or alternatively, the query representations may be generated in a JavaScript object notation (JSON) or extensible markup language (XML) format.

The differentiable program generator 110 may be configured to generate DNN programs 124(1)-(n) based on the query representations 122(1)-(n). For example, the differentiable program generator 110 may be configured to generate an initial DNN program 126(1) that employs tensor operations to perform the query 104(1) as represented by the query representation 122(1). In some examples, an initial DNN program 126 is a tensor program that employs tensor operations, or any other type of DNN program with DNN operations. Some examples of DNN operations include transposing, indexing, slicing, mathematical operations, linear algebra, random sampling, etc.

In some aspects, the differentiable program generator 110 is configured to map a query command in a query language (e.g., SQL) to one or more DNN operations even though the feature and/or command set of query languages and DNN APIs are vastly different and have different uses. For example, in some aspects, a query representation 122 may be a graph with each command of the query representation 122 represented as a node of the graph. Further, the differentiable program generator 110 may be configured to traverse the nodes of the graph, and determine the DNN operations of the initial DNN program 126 based on the one or more DNN operations corresponding to each node of the graph. Consequently, for example, the query processing system 102 may perform queries via hardware specialized (e.g., ASICs) and/or optimized for DNNs, thereby improving performance of query processing while reducing development effort, leveraging the cross-platform compilation capabilities of DNN runtimes, and providing the ability to perform queries including machine learning prediction.

Further, in some examples, the differentiable program generator 110 may provide DNN-based differentiable implementations of SQL operators (i.e., the differentiable operators 124), e.g., a differentiable group by function, differentiable aggregate expressions using sum, average, min, max, and count aggregates (with or without distinct), differentiable filter functions, etc. In some aspects, a differentiable operator 124 may be an algorithm composed of a sequence of differentiable operators and thus differentiable, and/or a differentiable operator 124 may be a DNN.

For example, in some aspects, a query representation 122 is a graph with a node corresponding to a group by function. Further, the differentiable program generator 110 may be configured to traverse the graph to the node, and add a differentiable group by 214 to the DNN program 126 based on the node. In some aspects, the differentiable program generator 110 may receive a flag or input parameter indicating that one or more query commands of a query 104 should be mapped to a differentiable operator 124. In some other aspects, the differentiable program generator 110 is configured to automatically determine that a query 104 includes query commands that should be mapped to a differentiable operator 124. For example, the differentiable program generator 110 may employ ML techniques and/or pattern matching to detect a query command within a query 104 that should be mapped to a differentiable implementation of a SQL operation. Consequently, for example, the query processing system 102 may combine neural network operators and SQL operators to generate queries 104 that are end-to-end differentiable and thus create neurosymbolic systems that are end-to-end trainable, thereby permitting SQL to be used as a modeling language for DL. As used herein, in some aspects, “neurosymbolic” may refer to combining neural operators with traditional logic and algorithms that process symbols extracted by the neural operators. As used herein, in some aspects, “end-to-end trainable” may refer to a system that is end-to-end differentiable (composed entirely of differentiable operators) and includes one or more trainable weights/parameters. This is in contrast to systems that may have only part of or none of its computation graph be differentiable, thus preventing direct optimization/training of the systems parameters using common supervised training procedure (i.e., defining a differentiable error (or loss) function and using gradient descent optimization).

In addition, in some examples, the differentiable program generator 110 may provide DNN-based implementations (e.g., tensor-based implementations) for the following relational operators: selection, projection, sort, group by aggregation, natural join (primary key-foreign key, hash-based, and sort-based implementations), left-outer, left-semi and left anti-joins. In addition, in some examples, the differentiable program generator 110 may provide DNN-based implementations (e.g., tensor-based implementations) for query expressions, e.g., comparison and arithmetic operations, functions on date data type, in, case, like statements, aggregate expressions using sum, average, min, max, and count aggregates (with or without distinct).

The training component 112 may be configured to train the initial DNN programs 126(1)-(n) corresponding to the queries 104(1)-(n) to generate the DNN programs 128(1)-(n). For example, the training component 112 may train the initial DNN program 126(1) to generate the DNN program 128(1), the initial DNN program 126(n) to generate the DNN program 128(n), and so forth. In particular, the training component 112 may be configured to train the ML models of the one or more UDFs of an initial DNN program 126 to generate the DNN program 128 over multiple iterations. In some aspects, the training component 112 may employ automatic differentiation via the differentiable operators 124 of an initial DNN program 126 to train the initial DNN program 126(1)-(n) to generate the DNN programs 128(1)-(n) over a plurality of DNN runtimes 114. For example, on some aspects, the training component 112 processes the overall output loss to generate gradient data for each parameter of a ML model being trained. Further, the training component 112 performs automatic differentiation by differentiating the overall output loss computed by the loss function with respect to each of the parameters to obtain gradient data for each parameter with respect to overall output loss. In some aspects, the loss function computes the overall loss based on outputs from the last layer of a neural network, and that the gradient data computed by the training component 112 is backpropagated to previous layers (i.e., hidden layers and input layer) of that same neural network to retrain the neurons.

The DNN runtime 114 may be an environment configured to execute the initial DNN programs 126(1)-(n) and the DNN programs 128(1)-(n) on the DNN data structures 126(1)-(n) over the one or more processing components 116(1)-(n) to generate the DNN program results 130(1)-(n) that may be used as the query responses 118(1)-(n). For example, the DNN runtime 114 may be a tensor runtime configured to execute tensor programs. In some aspects, the DNN runtime 114 may provide an executable environment or an interpreter that may be used to train DNN models during a training mode by the training component 112 and that can be used to evaluate the DNN models in a non-training mode (e.g., inference or classification mode). During the inference mode, input data can be applied to the DNN model inputs, and the input data can be processed (e.g., classified) in accordance with the training of the DNN model. For example, a DNN program 128 may execute within the DNN runtime 114 to generate inference information (i.e., a program result 130).

In some aspects, the bulk of the processing operations performed in implementing a DNN is in performing Matrix×Matrix or Matrix×Vector multiplications. Such operations are compute-bandwidth intensive and memory-bandwidth intensive, where the size of a matrix may be, for example, 1000×1000 elements (e.g., 1000×1000 numbers, each including a sign, mantissa, and exponent) or larger. In some aspects, the DNN runtime 114 may apply techniques to the DNN operations of the initial DNN programs 126(1)-(n) and the DNN programs 126(1)-(n) to reduce the demands for computation as well as memory bandwidth in a given system, whether the system includes a field programmable gate array (FPGA), computer processing unit (CPU), or another hardware platform. In some aspects, the DNN runtime is provided by a DNN library or framework (e.g., PyTorch, TensorFlow, Apache TVM, etc.).

The one or more processing components 116(1)-(n) may be implemented as a CPU, a graphics processing unit (GPU), a custom or an application specific integrated circuit (ASIC) (e.g., including a system-on-chip (SoC) integrated circuit), a FPGA or other reconfigurable logic, or as a soft processor virtual machine hosted by a physical, general-purpose processor. In addition, in some aspects, the one or more processing components 116(1)-(n) are configured to accelerate these basic machine learning computations and improve performance, reduce latency and reduce the costs of deploying machine learning based applications. Further, the DNN runtime 114 may be configured to execute the DNN programs 124(1)-(n) using processor specific details to further accelerate performance.

The data formatter 118 may be configured to generate DNN data structures 126(1)-(N) based on query data 134 of the data store 106. Further, the DNN data structures 126(1)-(n) may be input into the DNN programs 124(1)-(N) to determine query responses 118(1)-(n) to the queries 104(1)-(n).

As an example, the DNN program 126(1) may be a tensor program, and the data formatter 118 may generate the DNN data structures 126(1)-(n) as tensors to be input into the DNN program 126(1). As used herein, a “tensor” may refer to a generalization of vectors and matrices to potentially higher dimensions. In some aspects, a tensor is a data structure organized as an array of numbers. The tensor may be characterized by a degree or order of the tensor. A zeroth-order tensor is a scalar, a first-order tensor is a vector (i.e., a one-dimensional array), a second-order tensor is a two-dimensional array, and so forth. Each dimension of the tensor can have a different respective number of elements or values. In some examples, the data formatter 118 may generate a tensor for each column of a database table. In addition, the dimensionality of the tensor may be based at least in part on the type of data stored in the column. As an example, a column of integers or Boolean values in the data store 106 may be represented as a one dimension tensor (e.g., a vector), while a column of string values may be represented as a two dimensional tensor (e.g., a matrix).

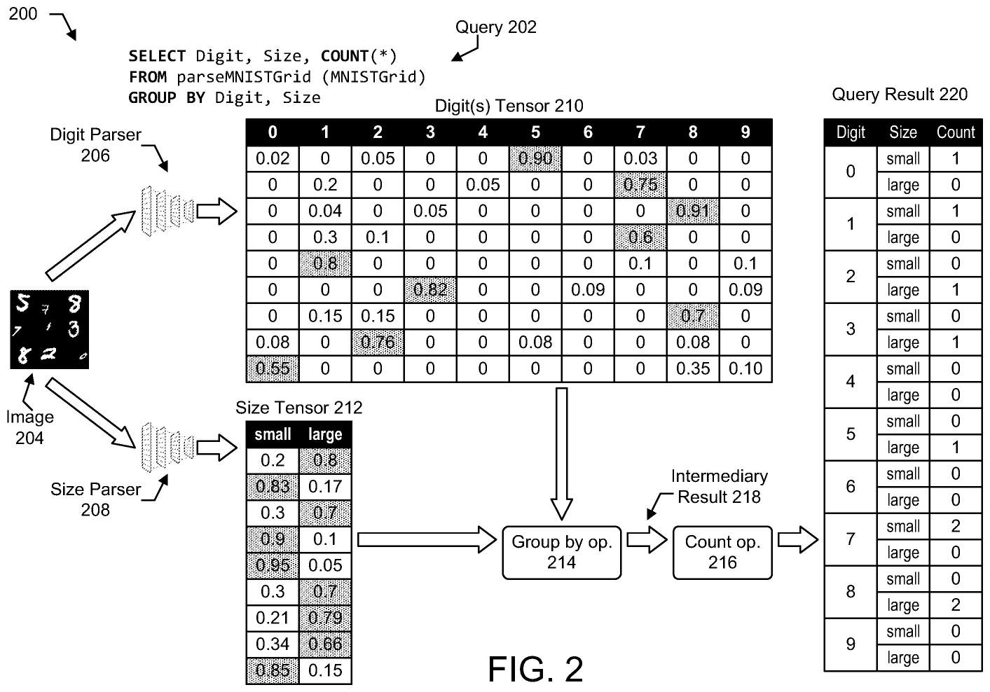

FIG. 2 is a diagram 200 illustrating example components of a trainable query, in accordance with some aspects of the present disclosure. As illustrated in FIG. 2, a query 202 includes a trainable UDF (i.e., parseMNISTGrid) that takes an image 204 (i.e., MNISTGrid) as an input parameter. Further, the query 202 includes query operators having an associated differentiable DNN operator (e.g., count and group by). In some aspects, the UDF includes a digit parser 206 for identifying digits within the image 204 and a size parser 208 for identifying the size of a digit within the image. As illustrated in FIG. 2, the digit parser 206 may generate a digit tensor 210 representing the likelihood of a plurality of digits within the image 204, the size parser may generate size tensor 212 representing the likelihood of the different digit sizes within the image. As described in detail herein, the query processing system 102 may train the digit parser 206 and the size parser 208 within a DNN runtime given the use of differentiable operators (i.e., the differentiable group by operation 214 and the differentiable count operation 216) for the query operators within the query 202.

In particular, the differentiable group by operation 214 may receive the digit tensor 210 and the size tensor 212 and generate the intermediary result 218, and the differentiable count operation 216 may receive the intermediary result 218 and generate the query result 220 indicating the number of small and large digits between 0-9. Further, the training component 112 may train the query based on the ML models (i.e., the digit parser 206 and the size parser 208) and the differentiability of the DNN operators (i.e., the differentiable group by operation 214 and the differentiable count operation 216) corresponding to the query operators of the query 202. In some aspects, the use of separate parsers (i.e., the digit parser 206 and the size parser 208) and the differentiable operators avoids entanglement of tasks by providing different elements for different tasks performed by a query as opposed to requiring a single ML model to perform all of the tasks of the query. Further, the ML models (e.g., the digit parser 206 and the size parser 208) may be generalized to other applications performing the same tasks.

### Example Processes

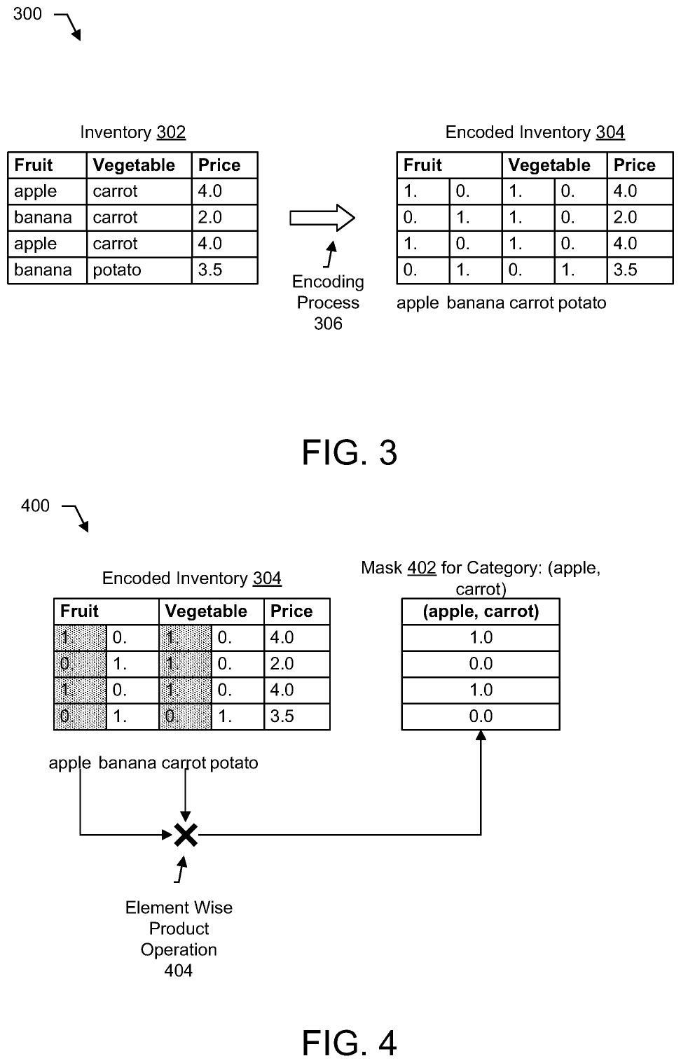

FIG. 3 is a diagram illustrating an example process 300 for encoding tabular information to implement a differentiable operation, in accordance with some aspects of the present disclosure. In some aspects, a first step of performing a differentiable operation includes encoding the tabular information input into the differentiable operation. For example, as illustrated in FIG. 3, the tabular information (i.e., inventory 302) representing an inventory of fruit-vegetable pairs is encoded into an encoded representation (i.e., encoded inventory 304) via an encoding process 306. In some aspects, the encoding process 306 is one hot encoding (OHE). In some aspects, encoding the tabular information relaxes the tabular information from discrete data to a continuous representation in order to format the data for differentiable operations.

FIG. 4 is a diagram illustrating an example process 400 for generating a mask from an encoded representation to implement a differentiable operation, in accordance with some aspects of the present disclosure. In some aspects, a second step of performing a differentiable operation includes generating a mask for individual categories within the encoding representation of the tabular information input into the differentiable operation. For example, as illustrated in FIG. 4, a mask 402 may be generated for a vegetable-fruit pair (i.e., the apple-carrot pair) of the encoded inventory 304. As illustrated in FIG. 4, the mask 402 for the apple-carrot pair may be generated by performing an element wise product operation 404 on the apple and carrot entries within the encoded inventory 304.

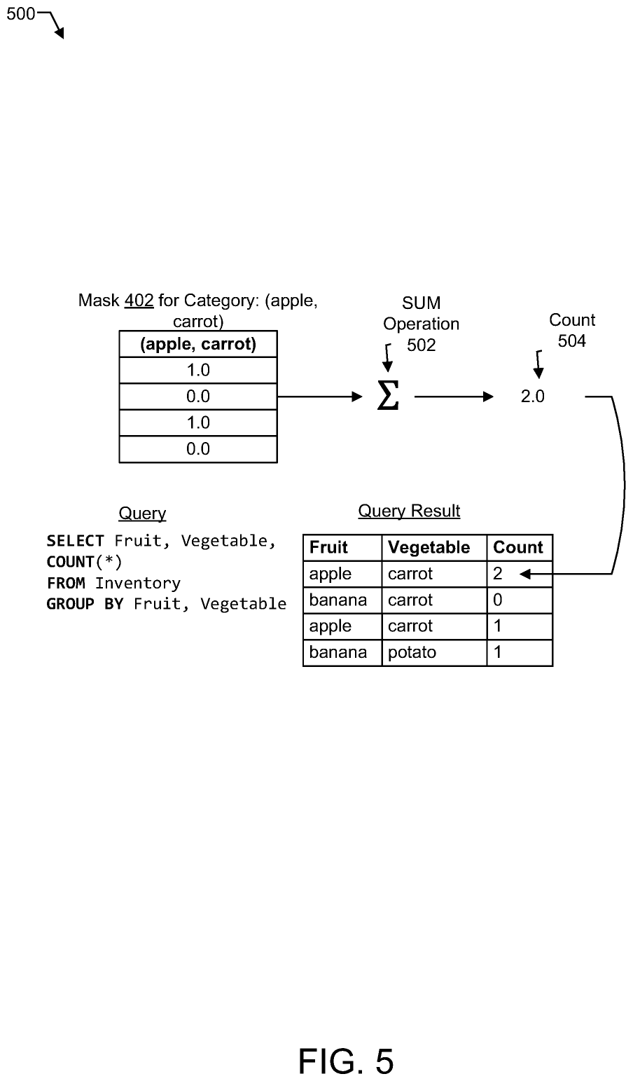

FIG. 5 is a diagram illustrating an example process 500 for implementing differentiable aggregation using count operation using a mask, in accordance with some aspects of the present disclosure. In some aspects, a query 104 includes a differentiable group by operation and a differentiable aggregation operation (e.g., the query 104 may be “SELECT Fruit, Vegetable, COUNT(*) FROM Inventory GROUP BY Fruit, Vegetable”). Further, performing the differentiable group by operation and the differentiable aggregation operation (e.g., count) includes generating a mask for a category as described with respect to FIGS. 3-4, and summing the entries of the mask to determine the count for the category. For example, as illustrated in FIG. 5, the rows of the mask 402 may be summed via a SUM operation 502 to determine the count 504 for the apple-carrot pair. Further, the query result includes the count for each of the pairs.

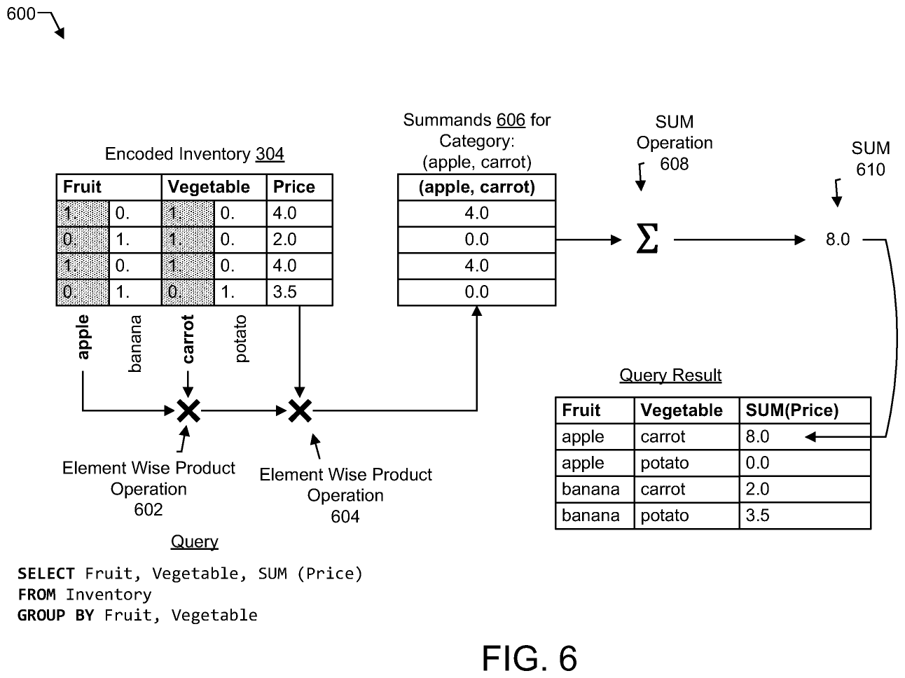

FIG. 6 is a diagram illustrating an example process 600 for implementing differentiable aggregation using sum operation using a mask, in accordance with some aspects of the present disclosure. In some aspects, a query 104 includes a differentiable group by operation and a differentiable aggregation operation (e.g., the query 104 may be “SELECT Fruit, Vegetable, SUM(Price) FROM Inventory GROUP BY Fruit, Vegetable”). Further, performing the differentiable group by operation and differentiable aggregation operation (e.g., sum) includes generating a mask for a category as described with respect to FIGS. 3-4, multiplying the mask by a column of values to determine a product result, and summing the entries of the product result to determine the sum of the values for the category. For example, as illustrated in FIG. 6, a first element wise product operation 602 may be employed to determine the mask 402, a second element wise product operation 604 of the mask and the price values may be employed to determine summands 606, and the summands 606 may be added via a SUM operation 608 to determine the sum 610 of the prices for the apple-carrot pair. Further, the query result includes the sum of the prices for each pair.

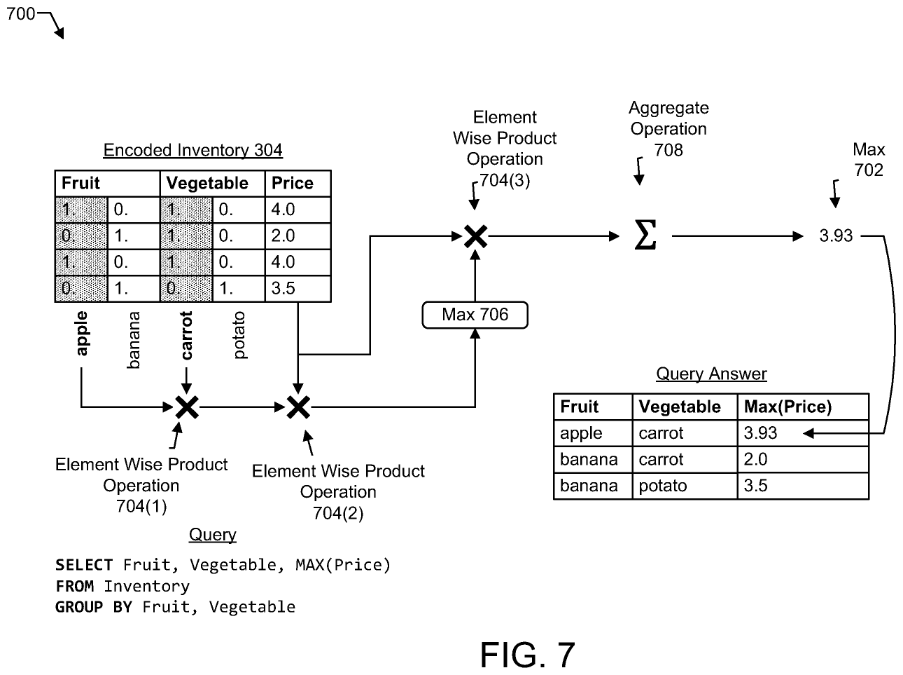

FIG. 7 is a diagram illustrating an example process 700 for implementing differentiable aggregation with max operation using a mask, in accordance with some aspects of the present disclosure. In some aspects, a query 104 includes a differentiable group by operation and a differentiable maximum value operation (e.g., the query 104 may be “SELECT Fruit, Vegetable, MAX(Price) FROM Inventory GROUP BY Fruit, Vegetable”). Further, performing the differentiable group by operation and the differentiable maximum value operation includes generating a mask for a category as described with respect to FIGS. 3-4, multiplying the mask by a column of values to determine a product result, and application of a differentiable maximum value operation to determine the maximum value for a category. For example, as illustrated in FIG. 7, the maximum value 702 for each category may be determined via a plurality of element wise product operations 704(1)-(3), a maximum value function 706 for continuous values (e.g., a softmax operation or sparsemax operation), and an aggregation operation 708. Further, the query result includes the max price for each pair.

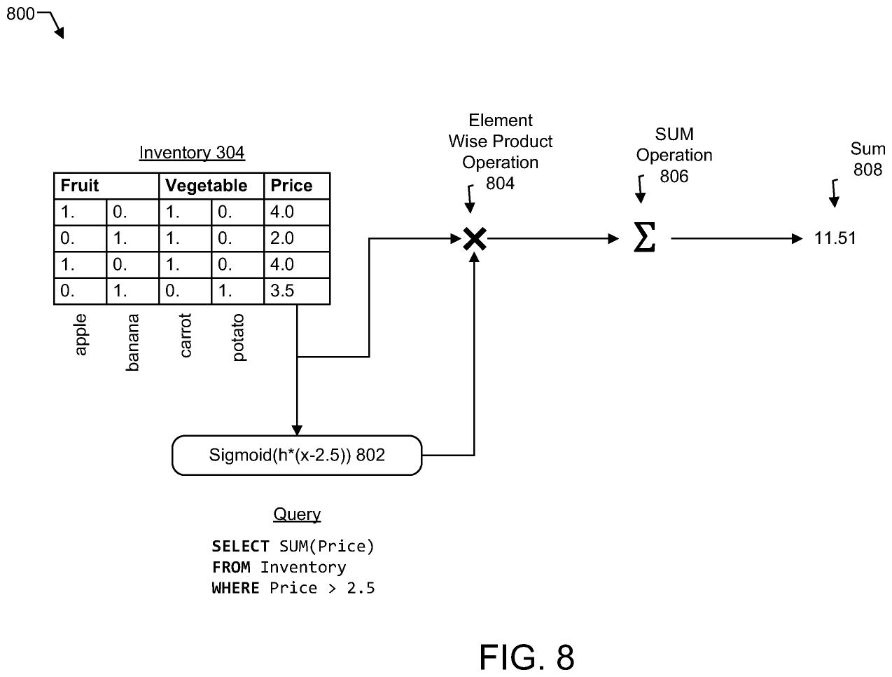

FIG. 8 is a diagram illustrating an example process 800 for implementing differentiable aggregation with a filter operation, in accordance with some aspects of the present disclosure. In some aspects, a query 104 includes a differentiable filter operation (e.g., the query 104 may be “SELECT SUM(Price) FROM Inventory WHERE Price >2.5”). For example, as illustrated in FIG. 8, a sigmoid function 802 and an element wise product operation 804 may be applied to filter the price values less than or equal to 2.5, and the values greater than 2.5 may be added via a SUM operation 806 to determine the sum 808 of the prices greater than 2.5.

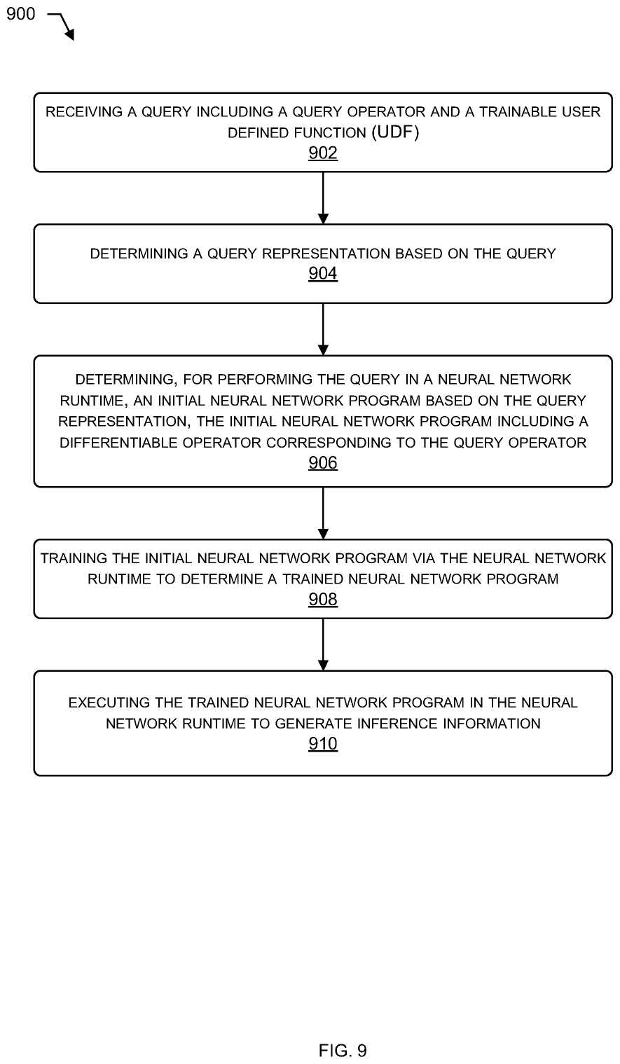

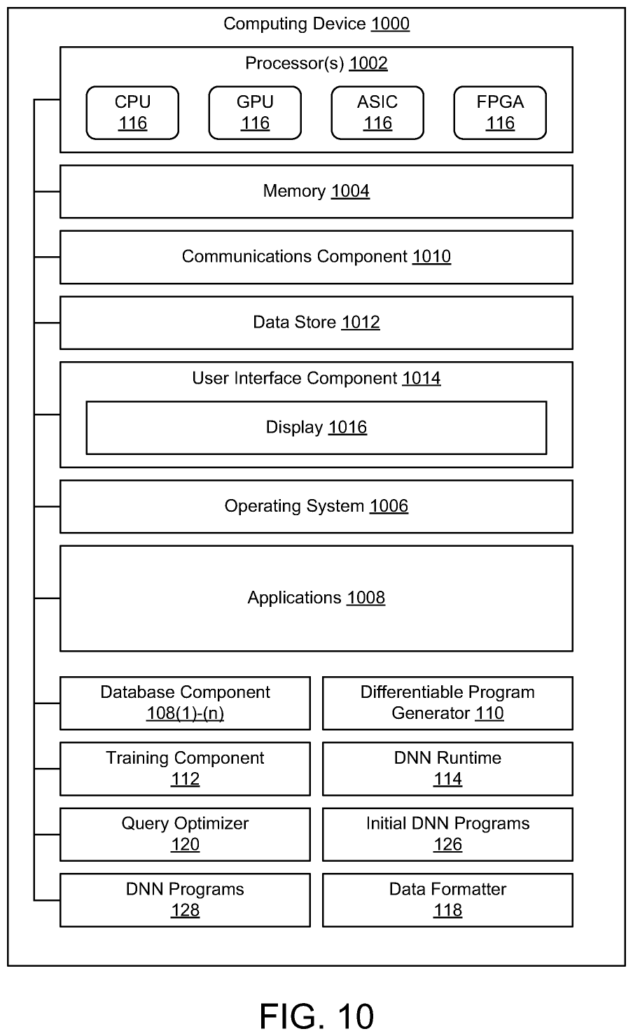

The processes described in FIG. 9 below are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the query processing system 102. By way of example and not limitation, the method 900 is described in the context of FIGS. 1-8 and 10. For example, the operations may be performed by one or more of the query processing system 102, the database component 108, the differentiable program generator 110, the training component 112, the DNN runtime 114, the data formatter 118, and one or more processing components 116.

FIG. 9 is a flow diagram illustrating an example method 900 extending query languages with differentiable operators, in accordance with some aspects of the present disclosure.

At block 902, the method 900 includes receiving a query including a query operator and a trainable user defined function (UDF). For example, the database component 108 may receive a query 104(1) including a query operator and a trainable UDF. Further, the UDF may reference one or more ML models, e.g., the digit parser 206 and the size parser 208.

Accordingly, the data processing system 100, the query processing system 102, the one or more processing components 116, the computing device 1000, and/or the processor 1002 executing the database component 108 may provide means for receiving a query including a query operator and a UDF.

At block 904, the method 900 includes determining a query representation based on the query. For example, the query optimizer 120 may generate a query representation 122(1) for the query 104(1). In some aspects, the query representation 122(1) may be a query plan for executing the query 104(1). In some aspects, the query representation 122(1) may be graph representation of an optimized strategy for executing the query 104(1).

Accordingly, the data processing system 100, the query processing system 102, the one or more processing components 116, the computing device 1000, and/or the processor 1002 executing database component 108 or the query optimizer 120 may provide means for determining a query representation based on the query.

At block 906, the method 900 includes determining, for performing the query in a neural network runtime, an initial neural network program based on the query representation, the initial neural network program including a differentiable operators corresponding to the query operator. For example, the differentiable program generator 110 may generate the initial DNN program 126(1) based on the query representation 122(1). In some aspects, the initial DNN program 126(1) may be a tensor program. Further, the initial DNN program 126(1) includes DNN operations for performing the query 104(1) in a DNN runtime 114. For example, the initial DNN program 126(1) includes tensor operations for performing the query 104(1) in a tensor runtime. In some aspects, the differentiable program generator 110 may generate the initial DNN program 126(1) by identifying one or more DNN operations corresponding to each of the query operators of the query representation 122(1). As described in detail herein, in some aspects, one or more of the DNN operations may be differentiable operators, as described with respect to FIGS. 1-8. Accordingly, the initial DNN program 126(1) is neuro-symbolic, and thus trainable.

Accordingly, the data processing system 100, the query processing system 102, the one or more processing components 116, the computing device 1000, and/or the processor 1002 executing the differentiable program generator 110 may provide means for determining, for performing the query in a neural network runtime, an initial neural network program based on the query representation, the initial neural network program including a differentiable operators corresponding to the query operator.

At block 908, the method 900 includes training the initial neural network program via the neural network runtime to determine a trained neural network program. For example, the training component 112 executing a plurality of DNN runtimes 114 may train the initial DNN program 126(1) to generate the DNN program 128(1) via automatic differentiation. Accordingly, the initial DNN program 126 may be trained to identify parameters best suited for performing inference via a query language (e.g., SQL).

Accordingly, the data processing system 100, the query processing system 102, the one or more processing components 116, the computing device 1000, and/or the processor 1002 executing the training component 112 may provide means for training the initial neural network program via the neural network runtime to determine a trained neural network program.

At block 910, the method 900 includes executing the trained neural network program in the neural network runtime to generate inference information. For example, the DNN runtime 114 may execute the DNN program 128(1) via one of the one or more processing components 116(1)-(n). For instance, the DNN runtime 114 may be a tensor runtime and the tensor runtime may execute the DNN program 128(1) on custom hardware configured to accelerate performance of the DNN program 128(1). Further, the DNN program may be executed based on query data 134 and/or data structures 132 and generate a DNN program result 130 including an inference. For instance, the DNN program 128 may be employed for at least a completely automated public Turing test to tell computers and humans apart (CAPTCHA), action recognition in video, multimodal search, differentiable privacy, and data cleaning.

Accordingly, the data processing system 100, the query processing system 102, the one or more processing components 116, the computing device 1000, and/or the processor 1002 executing the DNN runtime 114 may provide means for executing the trained neural network program in the neural network runtime to generate inference information.

In some aspects, the techniques described herein relate to a method, wherein the UDF includes at least one machine learning model, and training the initial neural network program includes training the machine learning model to determine the trained neural network program.

In some aspects, the techniques described herein relate to a method, wherein training the initial neural network program includes training the initial neural network program using automatic differentiation based on the differentiable operator to determine the trained neural network program.

In some aspects, the techniques described herein relate to a method, wherein training the initial neural network program includes: generating UDF output information by a machine learning model of the UDF; encoding the UDF output information to generate encoded information; determining a mask based on the encoded information; and generating the inference information based on inputting the mask into the differentiable operator.

In some aspects, the techniques described herein relate to a method, wherein training the initial neural network program includes training the initial neural network program using automatic differentiation based on the differentiable operator to determine the trained neural network program.

In some aspects, the techniques described herein relate to a method, wherein the differentiable operator includes a differentiable group by function, differentiable aggregate function, differentiable maximum function, differentiable minimum functions, or differentiable filter function.

In some aspects, the techniques described herein relate to a method, wherein the neural network runtime is configured to compile the trained neural network program over a plurality of processing hardware.

In some aspects, the techniques described herein relate to method, wherein the trained neural network program includes a tensor program, and the neural network runtime includes a tensor runtime.

While the operations are described as being implemented by one or more computing devices, in other examples various systems of computing devices may be employed. For instance, a system of multiple devices may be used to perform any of the operations noted above in conjunction with each other.

### Illustrative Computing Device

Referring now to FIG. 10, an example of a computing device(s) 1000 (e.g., query processing system 102). In one example, the computing device(s) 1000 includes the processor 1002 (e.g., the one or more processing components 116) for carrying out processing functions associated with one or more of components and functions described herein. The processor 1002 can include a single or multiple set of processors or multi-core processors. Moreover, the processor 1002 may be implemented as an integrated processing system and/or a distributed processing system. In an example, the processor 1002 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 1002 includes other processing components such as one or more arithmetic logic units (ALUs), registers, or control units.

In an example, the computing device 1000 also includes memory 1004 for storing instructions executable by the processor 1002 for carrying out the functions described herein. The memory 1004 may be configured for storing data and/or computer-executable instructions defining and/or associated with the query processing system 102, the queries 104(1)-(n), the data store 106, the database component 108, the differentiable program generator 110, the training component 112, the DNN runtime 114, the query responses 118(1)-(n), the data formatter 118, the query optimizer 120, query representations 122(1)-(n), the DNN programs 124(1)-(n), the DNN data structures 126(1)-(n), and the DNN program results 128(1)-(n), and the processor 1002 may execute the query processing system 102, the database component 108, the differentiable program generator 110, the training component 112, the DNN runtime 114, the data formatter 118, the query optimizer 120, and the DNN programs 124(1)-(n). An example of memory 1004 includes, but is not limited to, a type of memory usable by a computer, such as random access memory (RAM), read only memory (ROM), tapes, magnetic discs, optical discs, volatile memory, non-volatile memory, and any combination thereof. In an example, the memory 1004 may store local versions of applications being executed by processor 1002.

The example computing device 1000 includes a communications component 1010 that provides for establishing and maintaining communications with one or more parties utilizing hardware, software, and services as described herein. The communications component 1010 may carry communications between components on the computing device 1000, as well as between the computing device 1000 and external devices, such as devices located across a communications network and/or devices serially or locally connected to the computing device 1000. For example, the communications component 1010 includes one or more buses, and may further include transmit chain components and receive chain components associated with a transmitter and receiver, respectively, operable for interfacing with external devices. In an implementation, for example, the communications component 1010 includes a connection to communicatively couple a client device to the processor 1002.

The example computing device 1000 includes a data store 1012, which may be any suitable combination of hardware and/or software, that provides for mass storage of information, databases, and programs employed in connection with implementations described herein. For example, the data store 1012 may be a data repository for the operating system 1006 and/or the applications 1008.

The example computing device 1000 includes a user interface component 1014 operable to receive inputs from a user of the computing device 1000 and further operable to generate outputs for presentation to the user. The user interface component 1014 includes one or more input devices, including but not limited to a keyboard, a number pad, a mouse, a touch-sensitive display (e.g., display 1016), a digitizer, a navigation key, a function key, a microphone, a voice recognition component, any other mechanism capable of receiving an input from a user, or any combination thereof. Further, the user interface component 1014 includes one or more output devices, including but not limited to a display (e.g., display 1016), a speaker, a haptic feedback mechanism, a printer, any other mechanism capable of presenting an output to a user, or any combination thereof.

In an implementation, the user interface component 1014 may transmit and/or receive messages corresponding to the operation of the operating system 1006 and/or the applications 1008. In addition, the processor 1002 executes the operating system 1006 and/or the applications 1008, and the memory 1004 or the data store 1012 may store them.

Further, one or more of the subcomponents of the query processing system 102, the database component 108, the differentiable program generator 110, the training component 112, the DNN runtime 114, the data formatter 118, the query optimizer 120, and the DNN programs 124(1)-(n), may be implemented in one or more of the processor 1002, the applications 1008, the operating system 1006, and/or the user interface component 1014 such that the subcomponents of the query processing system 102, the database component 108, the differentiable program generator 110, the training component 112, the DNN runtime 114, the data formatter 118, the query optimizer 120, and the DNN programs 124(1)-(n), are spread out between the components/subcomponents of the computing device 1000.

### CONCLUSION

In closing, although the various embodiments have been described in language specific to structural features and/or methodological acts, it is to be understood that the subject matter defined in the appended representations is not necessary limited to the specific features or acts described. Rather, the specific features and acts are disclosed as example forms of implementing the claimed subject matter.

What is claimed is:

1. A method comprising:
receiving a query including a query operator and a trainable user defined function (UDF);
determining a query representation based on the query;
determining, for performing the query in a neural network runtime, an initial neural network program based on the query representation, the initial neural network program including a differentiable operator corresponding to the query operator;
training the initial neural network program via the neural network runtime to determine a trained neural network program; and
executing the trained neural network program in the neural network runtime to generate inference information.

2. The method of claim 1, wherein the UDF includes at least one machine learning model, and training the initial neural network program comprises training the at least one machine learning model to determine the trained neural network program.

3. The method of claim 1, wherein training the initial neural network program comprises training the initial neural network program using automatic differentiation based on the differentiable operator to determine the trained neural network program.

4. The method of claim 1, wherein training the initial neural network program comprises:
generating UDF output information by a machine learning model of the UDF;
encoding the UDF output information to generate encoded information;
determining a mask based on the encoded information; and
generating the inference information based on inputting the mask into the differentiable operator.

5. The method of claim 1, wherein training the initial neural network program comprises training the initial neural network program using automatic differentiation based on the differentiable operator to determine the trained neural network program.

6. The method of claim 1, wherein the differentiable operator includes a differentiable group by function, differentiable aggregate function, or differentiable filter function.

7. The method of claim 1, wherein the neural network runtime is configured to compile the trained neural network program over a plurality of processing hardware.

8. method of claim 1, wherein the trained neural network program includes a tensor program, and the neural network runtime includes a tensor runtime.

9. A non-transitory computer-readable device having instructions thereon that, when executed by at least one computing device, causes the at least one computing device to perform operations comprising:
receiving a query including a query operator and a trainable user defined function (UDF);
determining a query representation based on the query;
determining, for performing the query in a neural network runtime, an initial neural network program based on the query representation, the initial neural network program including a differentiable operator corresponding to the query operator;
training the initial neural network program via the neural network runtime to determine a trained neural network program; and
executing the trained neural network program in the neural network runtime to generate inference information.

10. The non-transitory computer-readable device of claim 9, wherein the UDF includes at least one machine learning model, and training the initial neural network program comprises training the at least one machine learning model to determine the trained neural network program.

11. The non-transitory computer-readable device of claim 9, wherein training the initial neural network program comprises training the initial neural network program using automatic differentiation based on the differentiable operator to determine the trained neural network program.

12. The non-transitory computer-readable device of claim 9, wherein training the initial neural network program comprises:
generating UDF output information by a machine learning model of the UDF;
encoding the UDF output information to generate encoded information;
determining a mask based on the encoded information; and
generating the inference information based on inputting the mask into the differentiable operator.

13. The non-transitory computer-readable device of claim 9, wherein training the initial neural network program comprises training the initial neural network program using automatic differentiation based on the differentiable operator to determine the trained neural network program.

14. The non-transitory computer-readable device of claim 9, wherein the differentiable operator includes a differentiable group by function, differentiable aggregate function, or differentiable filter function.

15. A system comprising:
a memory storing instructions thereon; and
at least one processor coupled with the memory and configured by the instructions to:
receive a query including a query operator and a trainable user defined function (UDF);
determine a query representation based on the query;
determine, for performing the query in a neural network runtime, an initial neural network program based on the query representation, the initial neural network program including a differentiable operator corresponding to the query operator;
train the initial neural network program via the neural network runtime to determine a trained neural network program; and
execute the trained neural network program in the neural network runtime to generate inference information.

16. The system of claim 15, wherein the UDF includes at least one machine learning model, and to train the initial neural network program, the at least one processor is further configured by the instructions to train the at least one machine learning model to determine the trained neural network program.

17. The system of claim 15, wherein to train the initial neural network program, the at least one processor is further configured by the instructions to train the initial neural network program using automatic differentiation based on the differentiable operator to determine the trained neural network program.

18. The system of claim 15, wherein to train the initial neural network program, the at least one processor is further configured by the instructions to:
generate UDF output information by a machine learning model of the UDF;
encode the UDF output information to generate encoded information;
determine a mask based on the encoded information; and
generate the inference information based on inputting the mask into the differentiable operator.

19. The system of claim 15, wherein to train the initial neural network program, the at least one processor is further configured by the instructions to train the initial neural network program using automatic differentiation based on the differentiable operator to determine the trained neural network program.

20. The system of claim 15, wherein the differentiable operator includes a differentiable group by function, differentiable aggregate function, or differentiable filter function.
